(19) United States
(12) Patent Application Publication
(10) Pub. No.: US 2025/0381942 A1
(43) Pub. Date: Dec. 18, 2025

(54) VEHICLE BRAKING APPARATUS

(71) Applicant: SUBARU CORPORATION, Tokyo (JP)

(72) Inventors: Katsuyuki ICHINOHE, Tokyo (JP); Kazuma SAITO, Tokyo (JP)

(21) Appl. No.: 19/218,777

(22) Filed: May 27, 2025

(30) Foreign Application Priority Data
Jun. 17, 2024 (JP) 2024-097498

(51) Int. Cl. B60T 13/58; F16D 65/18; F16D 65/38; F16D 121/04; F16D 121/24; F16D 123/00; F16D 125/06; F16D 125/40

(52) U.S. Cl. CPC B60T 13/588; F16D 65/18; F16D 65/38; F16D 2065/386; F16D 2121/04; F16D 2121/24; F16D 2123/00; F16D 2125/06; F16D 2125/40

(57) ABSTRACT

A vehicle braking apparatus includes a cylinder, a piston, an adjuster, and an engagement mechanism. A brake fluid is to be supplied to the cylinder. The piston is configured to slide by a fluid pressure of the brake fluid inside the cylinder. The adjuster is configured to move inside the piston in a sliding direction of the piston, and press the piston by a forward rotation of an electric motor of an electric parking brake. The engagement mechanism is configured to, upon a movement of the adjuster by a reverse rotation of the electric motor, cause the adjuster and the piston to be in engagement with each other, and release the engagement of the adjuster and the piston by an increase in the fluid pressure of the brake fluid inside the cylinder.

### CROSS-REFERENCE TO RELATED APPLICATIONS

The present application claims priority from Japanese Patent Application No. 2024-097498 filed on Jun. 17, 2024, the entire contents of which are hereby incorporated by reference.

### BACKGROUND

The disclosure relates to a vehicle braking apparatus.

International Publication No. 2011/158855 discloses an electric parking brake, or an electromechanical parking brake (EPB), that transmits a rotational force of an electric motor to a brake mechanism. Upon a braking operation, the EPB causes the electric motor to rotate in one direction, or a forward rotation, and transmits the rotational force of the electric motor to the brake mechanism, and stop the driving of the electric motor with a braking force being generated. Upon releasing of the brake, the EPB releases the braking force by causing the electric motor to rotate in a reverse direction, or a reverse rotation.

The brake mechanism of the EPB includes a mechanism that presses a piston provided inside a cylinder against a brake pad. The mechanism includes: a mechanism that slides the cylinder by a fluid pressure of a brake fluid to be supplied into the cylinder; and a mechanism that slides the piston by a driving force of the electric motor.

### SUMMARY

An aspect of the disclosure provides a vehicle braking apparatus that includes a cylinder, a piston, an adjuster, and an engagement mechanism. A brake fluid is to be supplied to the cylinder. The piston is configured to slide by a fluid pressure of the brake fluid inside the cylinder. The adjuster is configured to move inside the piston in a sliding direction of the piston, and press the piston by a forward rotation of an electric motor of an electric parking brake. The engagement mechanism is configured to, upon a movement of the adjuster by a reverse rotation of the electric motor, cause the adjuster and the piston to be in engagement with each other, and release the engagement of the adjuster and the piston by an increase in the fluid pressure of the brake fluid inside the cylinder.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a vehicle braking apparatus according to one example embodiment of the disclosure.

FIG. 2 is an explanatory diagram illustrating an engagement mechanism illustrated in FIG. 1, and is a cross sectional diagram taken along a line B-B illustrated in FIG. 3.

FIG. 3 is an explanatory diagram illustrating the engagement mechanism, and is a cross sectional diagram taken along a line A-A illustrated in FIG. 2.

FIG. 4 is an explanatory diagram illustrating an operation of the vehicle braking apparatus upon an operation of an electromechanical parking brake (EPB).

FIG. 5 is an explanatory diagram illustrating an operation of the vehicle braking apparatus upon releasing of the EPB.

FIG. 6 is an explanatory diagram illustrating an operation of the vehicle braking apparatus upon an activation of a main brake after the EPB is released.

FIG. 7 is an explanatory diagram illustrating an operation of the vehicle braking apparatus when a brake pad is worn.

FIG. 8 is an explanatory diagram illustrating an operation of the vehicle braking apparatus when the brake pad is worn.

### DETAILED DESCRIPTION

In an existing technique, such as that disclosed in International Publication No. 2011/158855, upon a braking operation of an electromechanical parking brake (EPB), a fluid pressure of a brake fluid is not generated, and an adjuster is moved by a forward rotation of a spindle rotated by an electric motor and a piston is pushed up by a shoulder of the adjuster accordingly. At this time, a pressing force of the piston causes a pressure deformation of a brake pad and a strain of a caliper. The piston is pushed out by an amount corresponding to an amount of the pressure deformation of the brake pad and an amount of the strain of the caliper to obtain braking of the brake.

Upon releasing of the brake by the EPB, the adjuster is returned by the reverse rotation of the spindle, but the piston does not follow a movement of the adjuster. The piston slightly returns by a sealing structure of the piston, but does not return by an amount corresponding to the amount of the pressure deformation of the brake pad and the amount of the strain of the caliper, which leads to a temporal generation of a drag resistance of the brake mechanism.

It is desirable to provide a vehicle braking apparatus that makes it possible to, in a brake mechanism of an electromechanical parking brake (EPB), suppress a drag resistance upon releasing of a brake and improve durability of the brake mechanism and a fuel consumption upon driving of a vehicle.

In the following, a vehicle braking apparatus according to some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

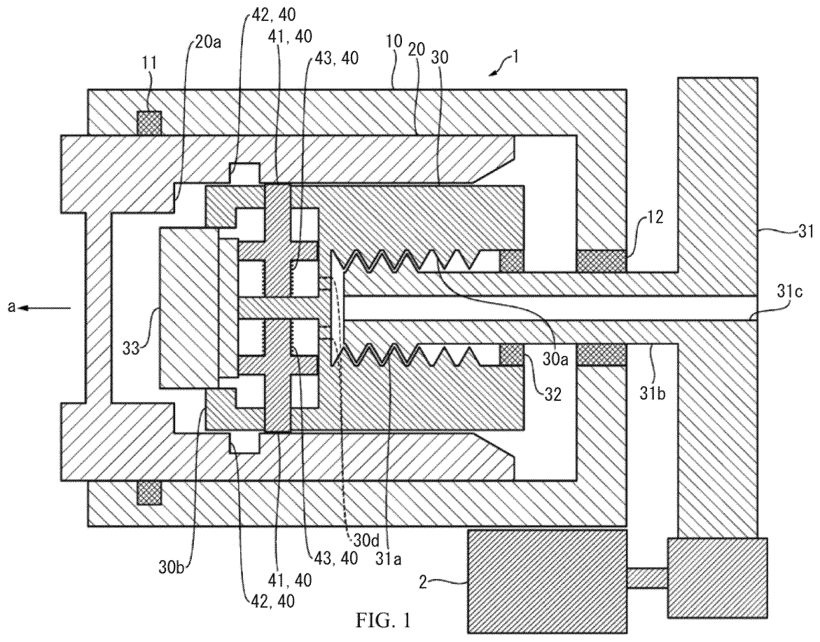

Referring to FIG. 1, a vehicle braking apparatus 1 according to an example embodiment of the disclosure includes at least a cylinder 10, a piston 20, and an adjuster 30. The cylinder 10 may slidably support the piston 20 via a piston seal 11. A brake fluid is to be supplied to the inside of the cylinder 10. The piston 20 slides by a fluid pressure of the brake fluid when the brake fluid is supplied into the cylinder 10. An increase in the fluid pressure of the brake fluid inside the cylinder 10 may cause the piston 20 to slide in a direction indicated by an arrow “a” and press an unillustrated brake pad to brake a vehicle accordingly.

The adjuster 30 is disposed inside the piston 20 and is movable in a sliding direction of the piston 20. The adjuster 30 is driven by an electric motor 2 of an electric parking brake, or an electromechanical parking brake. Hereinafter, the electromechanical parking brake is referred to as an EPB. The adjuster 30 presses the piston 20 in the direction indicated by the arrow “a” by a forward rotation of an electric motor 2 of the EPB. The adjuster 30 may move in a reverse direction to the direction indicated by the arrow “a” inside the piston 20 by a reverse rotation of the electric motor 2 of the EPB.

In an illustrated example embodiment, the adjuster 30 may have a female threaded part 30a to which a male threaded part 31a of a spindle 31 is screwed. When the spindle 31 is rotated in one direction by the electric motor 2, the adjuster 30 may move in the direction indicated by the arrow “a” and a shoulder 30b of the adjuster 30 may push an abutting part 20a inside the piston 20. When the spindle 31 rotates in a reverse direction by the electric motor 2, the adjuster 30 may move in an opposite direction to the direction indicated by the arrow “a” inside the piston 20. The spindle 31 may include a shaft 31b rotatably supported by the cylinder 10 via a sealing member 12. The male threaded part 31a may be inserted inside the adjuster 30 via the sealing member 32, and may be screwed into the female threaded part 30a.

The vehicle braking apparatus 1 includes an engagement mechanism 40 that causes the piston 20 and the adjuster 30 to be in engagement with each other. The engagement mechanism 40 engages the adjuster 30 and the piston 20 when the adjuster 30 is moved by the reverse rotation of the electric motor 2. The engagement mechanism 40 releases the engagement of the adjuster 30 and the piston 20 by an increase in the fluid pressure of the brake fluid inside the cylinder 10.

The engagement mechanism 40 may have an engagement pin 41 and an engagement groove 42. The engagement pin 41 may protrude from the inside of the adjuster 30 toward an inner surface of the piston 20. The engagement groove 42 may be provided on the inner surface of the piston 20 and to be engaged with the engagement pin 41. The engagement pin 41 may be inserted into the adjuster 30 by the increase in the fluid pressure of the brake fluid inside the engagement groove 42.

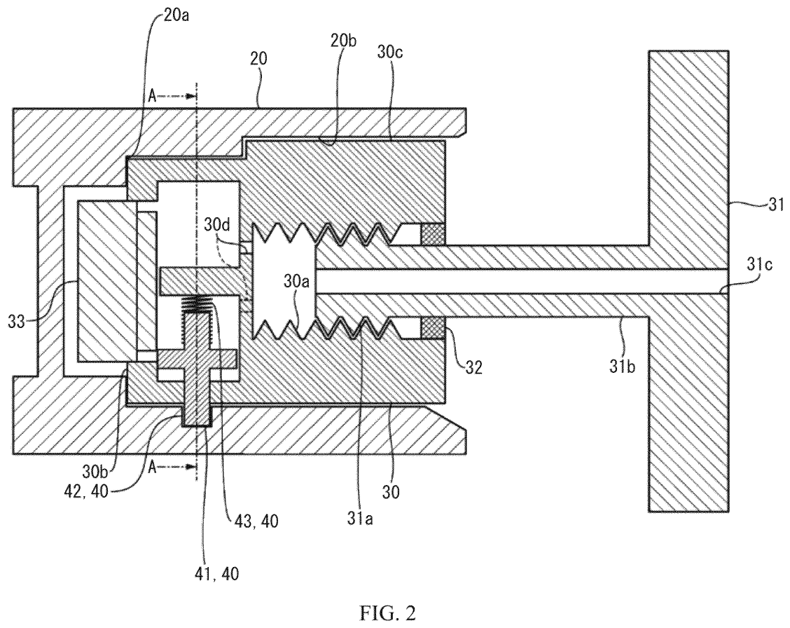

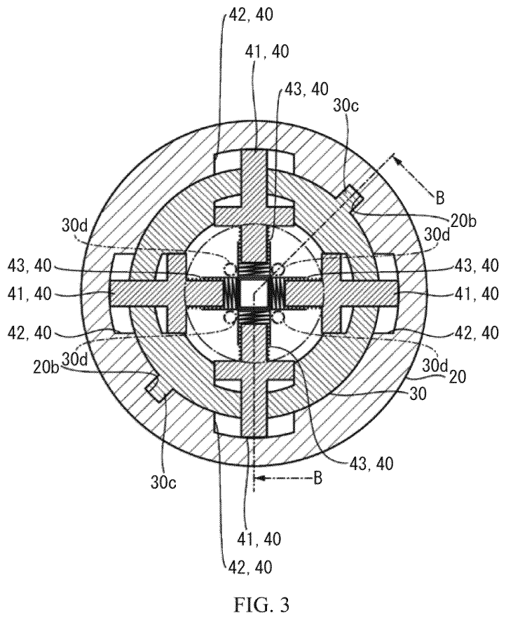

An example configuration of the engagement mechanism 40 will be described with reference to FIGS. 2 and 3. The adjuster 30 may have an internal space in which a proximal end of the engagement pin 41 is disposed. The proximal end of the engagement pin 41 may have a spring 43. The engagement pin 41 may have a distal end biased toward the inner surface of the piston 20 by the spring 43. The engagement mechanism 40 may have a region that does not fit in the engagement groove 42 and slides along the inner surface of the piston 20.

When the spindle 31 rotates without the fluid pressure of the brake fluid inside the piston 20, an engagement of a guide protrusion 30c of the adjuster 30 with a guide groove 20b of the inner surface of the piston 20 may cause the adjuster 30 to move inside the piston 20. When the distal end of the engagement pin 41 comes onto the engagement groove 42 of the inner surface of the piston 20, the distal end of the engagement pin 41 may protrude from an outer peripheral surface of the adjuster 30 by a biasing force of the spring 43 and may be fitted into the engagement groove 42. Accordingly, the piston 20 and the adjuster 30 may be integrally engaged with each other.

The inside of the adjuster 30 may be closed by a cover 33. A seal 32 may be provided around the shaft 31b of the spindle 31. This configuration may isolate the inside of the adjuster 30 from the brake fluid that enters the piston 20. The spindle 31 may have a vent hole 31c along the shaft 31b. In some embodiments, the inside of the adjuster 30 in which the engagement pin 41 is disposed may be communicated with the atmosphere via the vent hole 31c and a communication hole 30d.

The increase in the fluid pressure of the brake fluid inside the cylinder 10 may increase the fluid pressure of the brake fluid that enters the inside of the piston 20. When the fluid pressure of the brake fluid inside the engagement groove 42 becomes greater than the biasing force of the spring 43, the engagement pin 41 may be pressed by the fluid pressure of the brake fluid and inserted into the adjuster 30. This configuration may release the engagement of the piston 20 and the adjuster 30.

An operation of the vehicle braking apparatus 1 according to an example embodiment of the disclosure will be described. When a main brake is activated upon a non-operation state of the EPB and the fluid pressure of the brake fluid is applied into the cylinder 10 in a state illustrated in FIG. 1, the fluid pressure of the brake fluid inside the engagement groove 42 may increase, which releases the engagement of the piston 20 and the adjuster 30. Thus, the piston 20 may slide in the direction indicated by the arrow “a” and press the unillustrated brake pad accordingly. The main brake may be a brake that activates upon the non-operation state of the EPB. The main brake may be activated by an operation of a member such as an unillustrated brake pedal.

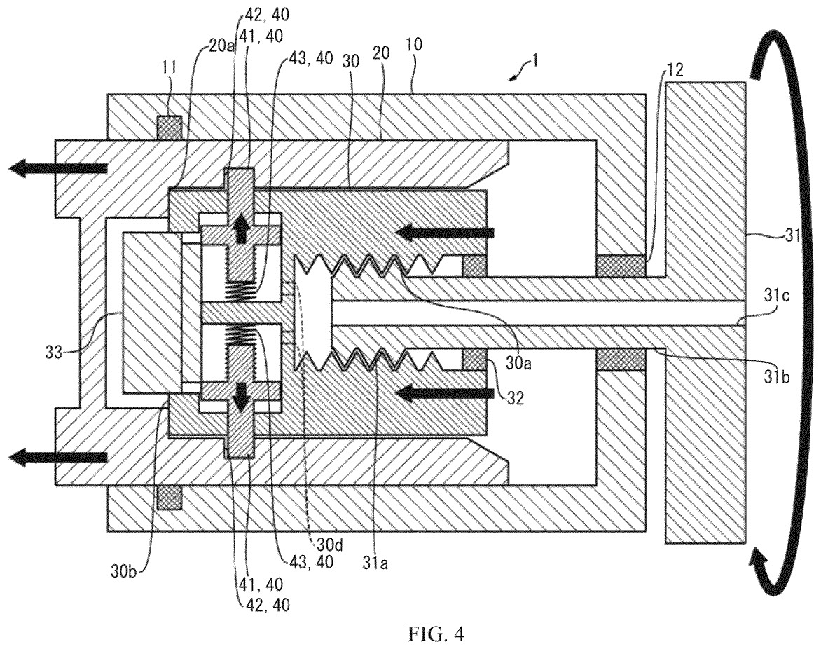

Referring to FIG. 4, when the EPB is operated with no fluid pressure of the brake fluid being applied inside the cylinder 10, the adjuster 30 may move inside the piston 20 in a direction indicated by an arrow by the rotation of the spindle 31. When the engagement pin 41 comes onto the engagement groove 42, the engagement pin 41 may be pushed by the spring 43 and may be fitted into the engagement groove 42. In addition, the adjuster 30 may press the piston 20 and the piston 20 may press the unillustrated brake pad accordingly.

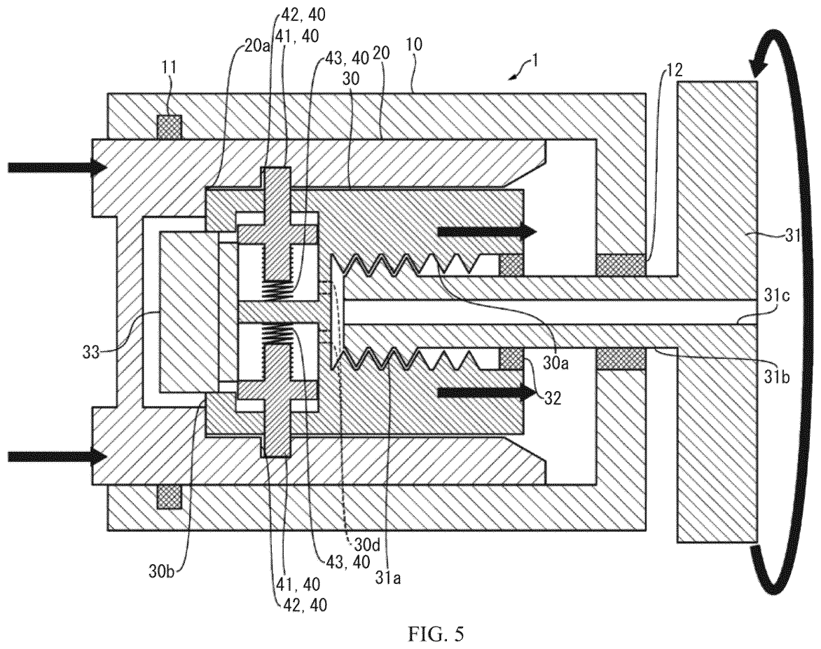

Referring to FIG. 5, when the EPB is released and a position of the adjuster 30 is returned by the reverse rotation of the spindle 31, the engagement of the piston 20 and the adjuster 30 by the engagement mechanism 40 may be maintained owing to the absence of the fluid pressure of the brake fluid inside the piston 20. In addition, the piston 20 may slide in an arrow direction with a movement of the adjuster 30, thereby forming a gap between the piston 20, the brake pad, and a rotor. This configuration helps to suppress a drag resistance upon releasing of the EPB.

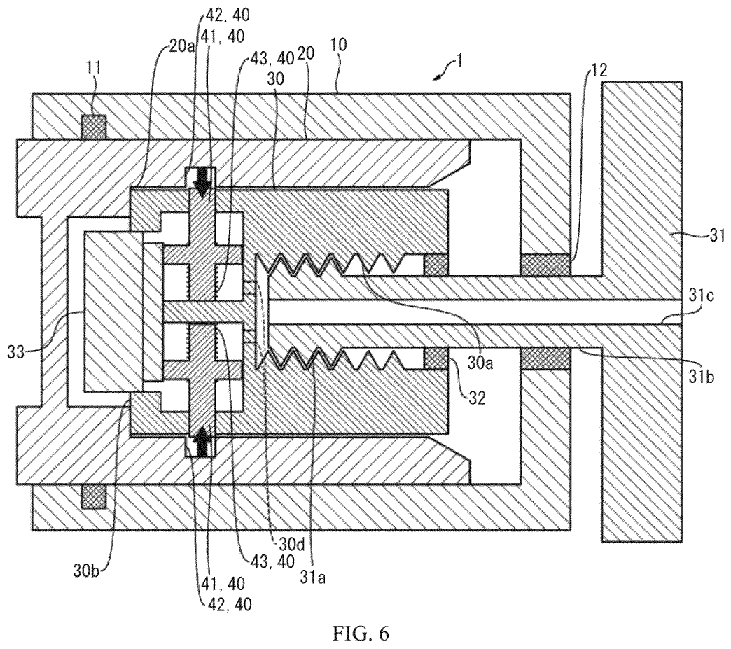

Further, when the main brake is activated with the piston 20 and the adjuster 30 being engaged with each other as illustrated in FIG. 5, the fluid pressure of the brake fluid inside the piston 20 may be increased by the application of the fluid pressure of the brake fluid inside the cylinder 10 as illustrated in FIG. 6. Referring to FIG. 6, when the fluid pressure of the brake fluid inside the engagement groove 42 exceeds the biasing force of the spring 43, the engagement pin 41 may be inserted into the adjuster 30, thereby releasing the engagement of the piston 20 and the adjuster 30. In addition, the piston 20 may independently move in an arrow direction as illustrated in FIG. 1 owing to the increase in the fluid pressure of the brake fluid inside the piston, and press the unillustrated brake pad accordingly.

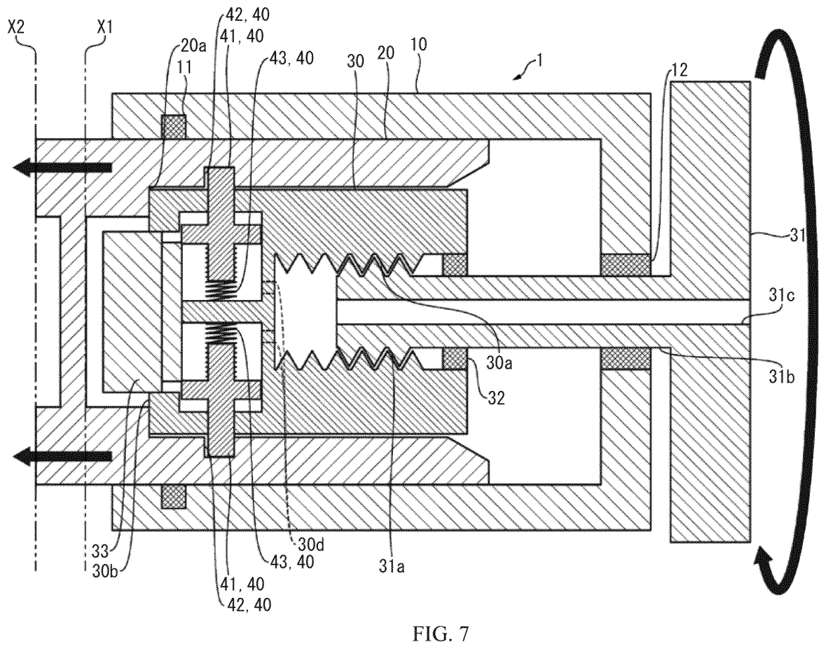

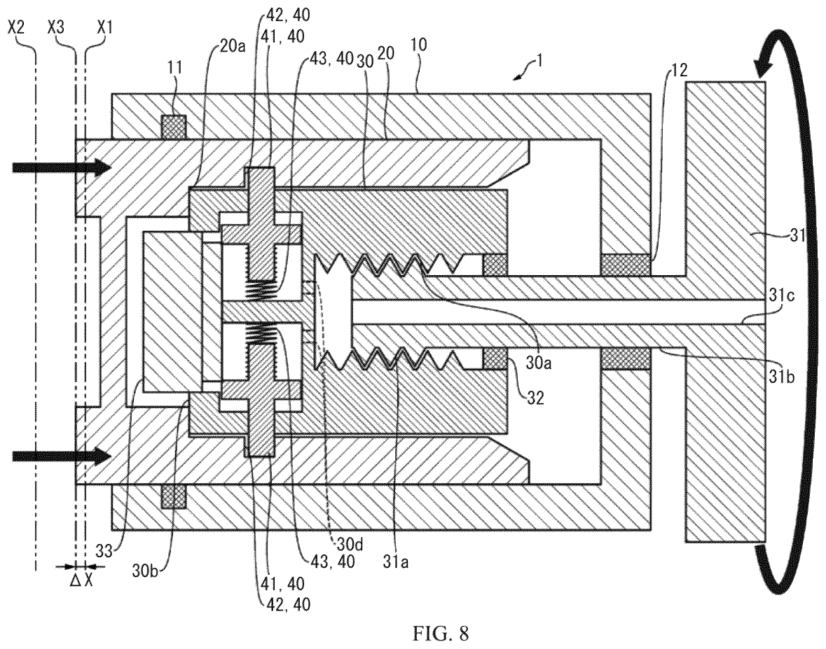

FIGS. 7 and 8 illustrate an example operation of the vehicle braking apparatus 1 when the brake pad is worn. When the EPB is activated with the brake pad being worn, the spindle 31 may rotate until the piston 20 presses the brake pad with a predetermined pressing force. In some embodiments, the predetermined pressing force may be 20 MPa. Thus, a distal end of the piston 20 may be pushed by the adjuster 30 and move from a position X1 that is before the operation of the EPB to a position X2 that is after the operation of the EPB as illustrated in FIG. 7.

Referring to FIG. 8, upon releasing of the EPB, the reverse rotation of the spindle 31 may return a position of the distal end of the piston 20 by a predetermined distance. In some embodiments, the predetermined distance may be one millimeter from the position X2. The position of the distal end of the piston 20 may be returned from the position X2 that is after the operation of the EPB to a position X3 that is at the time of the releasing of the EPB. Thus, the position of the distal end of the piston 20 that is before the operation of the EPB may be shifted from the initial position X1 to the position X3 that is deviated on a brake pad side by an amount of wear ΔX of the brake pad. Accordingly, this configuration helps to allow the position of distal end of the piston 20 that is before the operation of the EPB to be shifted to an appropriate position with respect to the brake pad and to maintain a responsiveness upon the activation of the brake, even when the brake pad is worn.

The vehicle braking apparatus 1 according to an example embodiment of the disclosure may cause the piston 20 and the adjuster 30 to be disengaged and thus allow the piston 20 to slide independently in accordance with the fluid pressure of the brake fluid to thereby press the brake pad, upon the activation of the main brake where the fluid pressure of the brake fluid inside the cylinder 10 increases. Upon the operation of the EPB, the piston 20 may be pushed by the adjuster 30 that is moved by the rotation of the spindle 31 and thus slide to thereby apply the predetermined pressing force to the brake pad. Upon releasing of the EPB, the piston 20 and the adjuster 30 may be engaged with each other, allowing the piston 20 to be so returned by the predetermined distance as to follow the adjuster 30 that is moved by the reverse rotation of the spindle 31. This configuration helps to form the gap between the rotor, the brake pad, and the piston upon releasing of the EPB, which in turn helps to suppress an occurrence of the drag resistance.

In some embodiments, when the brake pad is worn, the position of the distal end of the piston 20 which is before the operation of the EPB may be shifted toward the brake pad in accordance with the amount of the wear of the brake pad. This configuration helps to maintain the appropriate responsiveness upon the activation of the brake even when the brake pad is worn.

According to at least one embodiment of the disclosure, it is possible to, in a brake mechanism of an electromechanical parking brake (EPB), suppress a drag resistance upon releasing of a brake and improve durability of the brake mechanism and a fuel consumption upon driving of a vehicle.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. The techniques according to the example embodiments and their modification examples described above may be combined with each other in any combination unless any contradiction occurs in terms of their purposes, configurations, etc.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The invention claimed is:

1. A vehicle braking apparatus comprising:
a cylinder in which a brake fluid is to be supplied;
a piston configured to slide by a fluid pressure of the brake fluid inside the cylinder;
an adjuster configured to move inside the piston in a sliding direction of the piston, and press the piston by a forward rotation of an electric motor of an electric parking brake; and
an engagement mechanism configured to, upon a movement of the adjuster by a reverse rotation of the electric motor, cause the adjuster and the piston to be in engagement with each other, and release the engagement of the adjuster and the piston by an increase in the fluid pressure of the brake fluid inside the cylinder.

2. The vehicle braking apparatus according to claim 1, wherein
the engagement mechanism comprises an engagement pin configured to protrude from an inside of the adjuster toward an inner surface of the piston,
the cylinder comprises an engagement groove provided on an inner surface of the cylinder and configured to be engaged with the engagement pin, and
the engagement pin is configured to be inserted into the adjuster by the increase in the fluid pressure of the brake fluid inside the engagement groove.

3. The vehicle braking apparatus according to claim 1, wherein the adjuster comprises an internal space that is communicated with atmosphere through a vent hole provided inside a spindle, the spindle being configured to transmit the rotation of the electric motor.
